(19) United States
(12) Patent Application Publication
(10) Pub. No.: US 2010/0128863 A1
(43) Pub. Date: May 27, 2010

(54) CONTEXT AWARE VOICE COMMUNICATION PROXY

(75) Inventors: David Michael Krum, Monterey Park, CA (US); Jens Faenger, Santa Clara, CA (US)

Correspondence Address: TAFT STETTINIUS & HOLLISTER LLP, ONE INDIANA SQUARE, SUITE 3500, INDIANAPOLIS, IN, 46204, US

(73) Assignee: Robert Bosch GmbH, Stuttgart (DE)

(21) Appl. No.: 12/275,733

(22) Filed: Nov. 21, 2008

(51) Int. Cl. H04M 3/42

(52) U.S. Cl. 379/207.02

(57) ABSTRACT

A method of operating a telephone system includes receiving an incoming call to an operator of a machine. The operator has access to a telephonic device. A circumstance associated with operation of the machine is sensed. It is decided, dependent upon the sensed circumstance, whether to place the call to the telephonic device.

### COPYRIGHT NOTICE

Portions of this document are subject to copyright protection. The copyright owner does not object to facsimile reproduction of the patent document as it is made available by the U.S. Patent and Trademark Office. However, the copyright owner reserves all copyrights in the software described herein and shown in the drawings. The following notice applies to the software described and illustrated herein: Copyright© 2008, Robert Bosch GmbH, All Rights Reserved.

### BACKGROUND OF THE INVENTION

1. Field of the Invention

The present invention relates to an interface for receiving and screening incoming phone calls to a preoccupied user.

2. Description of the Related Art

Hands free telephone devices, ranging from headsets to systems installed in vehicles, are often employed in situations in which the user is engaged, physically and/or mentally, in a task other than conducting telephone calls. When a phone call is received, the device forwards the call immediately to the user's attention, regardless of, and without knowledge of, what activity the user is currently engaged in.

A problem with such hands free telephone devices is that they may interrupt the user with an incoming call when the user is performing a task that requires his full attention. For example, the user may be driving a vehicle in high traffic or on icy roads when an incoming phone call arrives. The incoming call may distract the driver to a degree that it causes an accident. Even if the user does not take the call, he may be distracted by the ringing of the phone.

The most widely deployed, state of the art solutions for handling calls while a driver is busy involve forwarding calls to other parties like secretaries, answering services, or voice mail systems. The driver hears through ringing that a call has come in. The driver may also see a display on the device or in the vehicle that indicates an incoming call plus caller identification information if available. A distinctive ring which is associated with the particular caller may also be used. The driver must then assess whether he is too busy to answer the phone and then either answer, reject, or let the call be forwarded to voice mail or another party.

A shortcoming of known technology is that the driver may not always be able to see or hear the caller identification information. Moreover, if the call is not answered, the caller may have no information about the driver's situation or why the call was not answered, even if the driver trusts the caller and wishes the caller to have this information. The current state of the art system is also unable to determine if the driver is too busy to answer the call. Handling the call, even by rejecting or deciding not to pick up, may be too distracting for the driver. Furthermore, no information about the driving situation is made available to the current system which could be used for communicating the situation to the caller or automatically deciding how to handle the call.

Known technologies also include interactive voice response systems, such as those employed by customer service organizations and airline reservation systems. These allow users to identify themselves and make inquiries about particular kinds of information, such as the status of certain flights. These are typically deployed by large organizations rather than by individuals. These systems are not made aware of vehicle situations.

There are also virtual personal assistants, such as Wildfire from CR Technology, Inc., which use voice recognition to provide assistance to an individual when they are initiating and receiving calls, or even within the duration of a call. The caller can ask the system to dial a particular number, make changes to contact lists, return calls, and many other tasks. These systems are not made aware of vehicle situations.

The prior art further includes some research concepts and prototypes that provide additional technologies and features that address some of the current shortcomings. Context Call is a system that allows callers and the called parties to exchange context before connecting the call. This system allows users to set their status, also known as context, on the phone (e.g., at home, at work, in a meeting, or busy). When callers try to call, they are made aware of the user's status setting. For example, if they call and the user's status is “in a meeting,” they can decide to place the call anyway. This is socially appropriate if the call concerns information required for the meeting. A social faux pas would be made if the call was irrelevant and disrupted the meeting. This system does not identify the caller and determine trust levels.

Another known system that allows the exchange of context information prior to connecting calls is the Context Phonebook which collects status information from many users and displays this information in the contact list of the phone. Users may exchange their context in terms of availability: available, busy, or emergency calls only, and in terms of location: at home, at work, or on the way to work. This exchange of context is intended to provide leveraging of appropriate social behaviors similarly to Context Call. This system does not use caller identity to determine the amount and type of context to share.

Quiet Calls and Touch-Talk are similar known systems which enable a called party to quickly and quietly answer calls in situations where the called party cannot speak. The called party can listen to the caller's questions and respond by pressing buttons to select the play back of an appropriate pre-recorded message to the caller in lieu of speaking. The called party thus uses the messages as a proxy to handle the call without speaking. With these systems, the called party must still handle the call, but can do so without speaking.

Yet another known technology is SenSay, which is a context-aware mobile phone that uses sensors to determine the called user's context. This allows the system to appropriately change ringer volume, vibration, and phone alerts according to the called user's context. The system sends a short message service (SMS) text message to the caller informing the caller that the called party was too busy to answer. This message also states that the caller may call again within a particular time period if the call is urgent. This second call is given higher priority in alerting the user. This system displays some intelligence in understanding the called party's situation, but cannot speak to the caller on the called party's behalf.

What is neither disclosed nor suggested by the prior art is a telephone interface device that automatically discerns whether a vehicle operator is in a situation in which he should not be distracted, and that forwards incoming calls to the user based upon the demands of the current situation. What is also neither disclosed nor suggested by the prior art is a telephone interface device that, when it decides not to put an incoming call through to a driver, provides a caller with information about the driver's situation or why the call was not answered.

### SUMMARY OF THE INVENTION

The present invention may provide an intelligent agent that can answer the phone or other voice communication device when a user, such as an operator of a vehicle or other machine, is otherwise engaged. The specific embodiment in which the user is a driver of a vehicle is disclosed herein, although the scope of the invention may encompass any preoccupied user. The intelligent agent may use sensors to monitor the driver, vehicle state, and environmental conditions to determine whether the operator is too busy to respond. The agent can engage the caller in a conversation, collecting information from the caller, and offering information about the vehicle operator to the caller, depending on the caller's identity and level of trust.

The invention presents an intelligent, automated proxy for answering voice communications when a vehicle operator (driver) is too busy to answer the communication. The proxy may use information from the driver navigation system as well as from sensors that monitor the state of the driver, vehicle, and environmental conditions such as terrain and traffic to make a determination of the ability of the driver to answer the call. If the driver is judged unable to answer the call, or instructs the proxy to answer the call, the proxy may engage the caller in a conversation to collect information from the caller concerning identity and the nature and urgency of the call. If the caller is a trusted party, the proxy may volunteer information about the driver's state, such as location, expected time of arrival, personal schedule, etc.

The present invention provides a novel synthesis or integration of technologies that may be aware of the driver's context (surround sensing) with caller identification, voice recognition and dialog management. The invention may provide assistance to the driver by answering incoming calls and communicating with the caller by means of a natural language dialogue system. The invention may authenticate whether a caller is trusted through multiple means, either Caller ID when available or through interrogation of the caller by a natural language dialogue system that asks the caller to identify himself and optionally provide additional responses to identity verifying questions. These responses from the caller are processed and recognized.

The present invention may provide the limited option of recording a message to callers who are not trusted parties, but may provide several options (recording a message, requesting a break-in or urgent connection, or asking the system questions about the driver's situation) to callers who are trusted. A break-in may include putting the call through to the called party despite (i.e., overriding) the called party being engaged in another telephone call or otherwise not being configured to accept the call. Summary information about the driver's situation may be relayed to the caller so that the caller has the context information required to decide the appropriate option to choose. A natural language dialogue system may answer questions from the caller in lieu of the driver, relating specific pieces and types of information according to the trustworthiness level of the caller.

Summary caller information may be relayed to the driver. The call may be handed off to the driver if warranted, or if the driver requests, but the driver may be enabled to defer the call.

The invention comprises, in one form thereof, a method of operating a telephone system, including receiving an incoming call to an operator of a machine. The operator has access to a telephonic device. A circumstance associated with operation of the machine is sensed. It is decided, dependent upon the sensed circumstance, whether to place the call to the telephonic device.

The invention comprises, in another form thereof, a telephone system including at least one sensor for sensing a circumstance associated with operation of a machine. A processor is communicatively coupled to the at least one sensor. The processor receives a call intended for an operator of the machine and decides whether to forward the call to the operator, ask the operator how to handle the call, or record a message associated with the incoming call. The decision is made dependent upon the circumstance sensed by the at least one sensor.

The invention comprises, in yet another form thereof, a method of operating a telephone system, including receiving an incoming call from a caller to an operator of a machine. The operator has access to a telephonic device. A circumstance associated with operation of the machine is sensed. A level of trust associated with the caller is determined. It is decided, dependent upon the sensed circumstance, whether to automatically place the call to the telephonic device. If the deciding step includes deciding not to automatically place the call to the telephonic device, then, depending upon the level of trust associated with the caller, the caller is prompted to leave a message for the operator, cause the call to break-in to the operator, and/or ask a question regarding operation of the machine.

An advantage of the present invention is that it may remove distractions to vehicle operators that are presented by voice communications devices such as cell phones and radios, particularly when vehicle operators are negotiating difficult situations, such as merging onto a freeway, driving in heavy traffic, changing lanes, making turns, and maneuvering to avoid pedestrians and other vehicles.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a block diagram of one embodiment of a vehicle including an in-vehicle telephone system of the present invention.

FIG. 2A is a first portion of a flow chart of one embodiment of a voice proxy method of the present invention.

FIG. 2B is a second portion of a flow chart of one embodiment of a voice proxy method of the present invention.

FIG. 2C is a third portion of a flow chart of one embodiment of a voice proxy method of the present invention.

FIG. 3 is a flow chart illustrating another embodiment of a voice proxy method of the present invention.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DESCRIPTION OF THE PRESENT INVENTION

The present invention may be described herein in terms of algorithms and operations on computer-generated displays. It has proven convenient, primarily for reasons of common usage among those skilled in the art, to describe the invention in terms of algorithms and operations on displays on a computer screen. It is to be understood, however, that these and similar terms are to be associated with appropriate physical elements, and are merely convenient labels applied to these physical elements. Unless otherwise stated herein, or apparent from the description, terms such as “receiving”, “determining”, “processing”, “sensing”, “choosing”, “identifying”, “providing” or “deciding”, or similar terms, may refer to the actions of a computing device that may perform these actions automatically, i.e., without human intervention, after being programmed to do so.

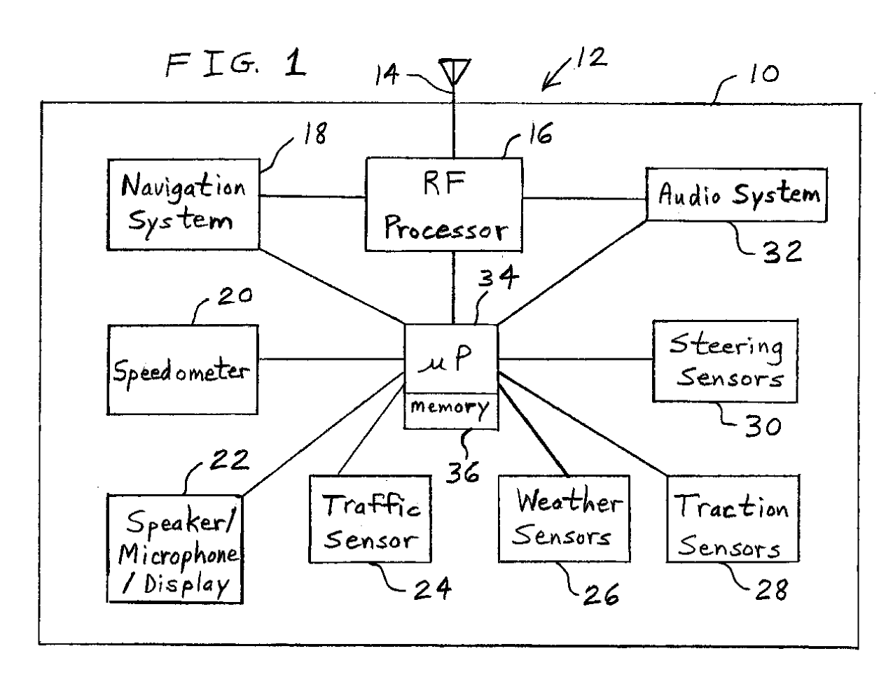

Referring now to the drawings, and particularly to FIG. 1, there is shown one embodiment of a vehicle 10 including an in-vehicle telephone system 12 of the present invention. System 12 includes an antenna 14, a radio frequency processor 16, a navigation system 18 (such as a GPS system), a speedometer 20, a user interface 22 (including a speaker, microphone and display screen), a traffic sensor system 24 (such as a RADAR or infrared sensor system), weather sensors 26 (such as sensors for detecting temperature, light level, precipitation, and wind speed), traction sensors 28 (such as for sensing a level of traction between the tires and the road), steering sensors 30 (such as for sensing a direction in which the vehicle is being steered), an audio system 32 (such as a radio), a microprocessor 34 and a memory device 36. System 12 may also include driver behavior sensors (not shown), such as eyelid sensors for sensing blinking by the driver, motion sensors and/or carbon dioxide sensors, for example.

As described in more detail below, telephone system 12 may provide a voice proxy which receives an incoming telephone call on antenna 14, and the call may be forwarded to microprocessor 34 via RF processor 16. The circumstances in which vehicle 10 is operating may be sensed by navigation system 18, speedometer 20, traffic sensor system 24, weather sensors 26, traction sensors 28, and steering sensors 30. Depending upon these sensed circumstances, processor 34 controls whether, and to what extent, the incoming phone call is forwarded to user interface 22 for presentation to the user, who may be the driver of vehicle 10. More generally, the user may operate any type of machine, such as a vehicle, office machine, or factory machine, for example.

Telephone system 12 may monitor the driver, vehicle state, and environmental conditions to determine situations in which the driver should not be distracted by a call. In these cases, and when the driver indicates, the proxy may answer the call and start a human-like (also known as natural language) conversation with the caller. This conversation may include the use of natural language understanding technology to deliver spoken questions to the caller, and parse what the caller is saying. Using caller ID and/or natural language questions, the proxy may identify the caller. If the caller is identified as a trusted party, the proxy may volunteer information about the current traffic conditions, location, destination, arrival time, personal schedule of the operator, or a personalized message for the caller. The caller may be given the opportunity to ask the voice proxy about the driver, the driver's situation, and even the driver's schedule. Since multiple levels of trustworthiness may be defined and assigned to callers, the information that the voice proxy shares may vary in specificity and content. Very trusted users may also be given the opportunity, for an emergency or urgent need, to prompt the vehicle operator for permission to connect and speak directly with the vehicle operator.

Information gathered from the caller may include the caller's identity, the nature and urgency of the call, and questions the caller might have for the vehicle operator. This information may be recorded for playback to the vehicle operator and presented to the vehicle operator while the caller is still on the line, or after the caller has concluded the call, depending on the availability and trustworthiness of the caller. The vehicle operator may be presented with the information and may have the option to connect to the call, call back later, or ignore the call.

Automatic call answering may be employed in situations in which a driver is operating a vehicle under heavy traffic conditions. During this operation, a call may come in on a mobile communications device, such as a cellular telephone or radio. Since information systems in the vehicle, such as speedometer 20, traffic sensor 24, and steering sensors 30, can sense heavy driving conditions through sensing of driver behavior, vehicle dynamics, as well as other internal and external sensors, the system may determine that the driver is occupied and unable to answer the call. The system can display to the driver that a call is coming in, if it is determined that such a display would not disrupt the driver.

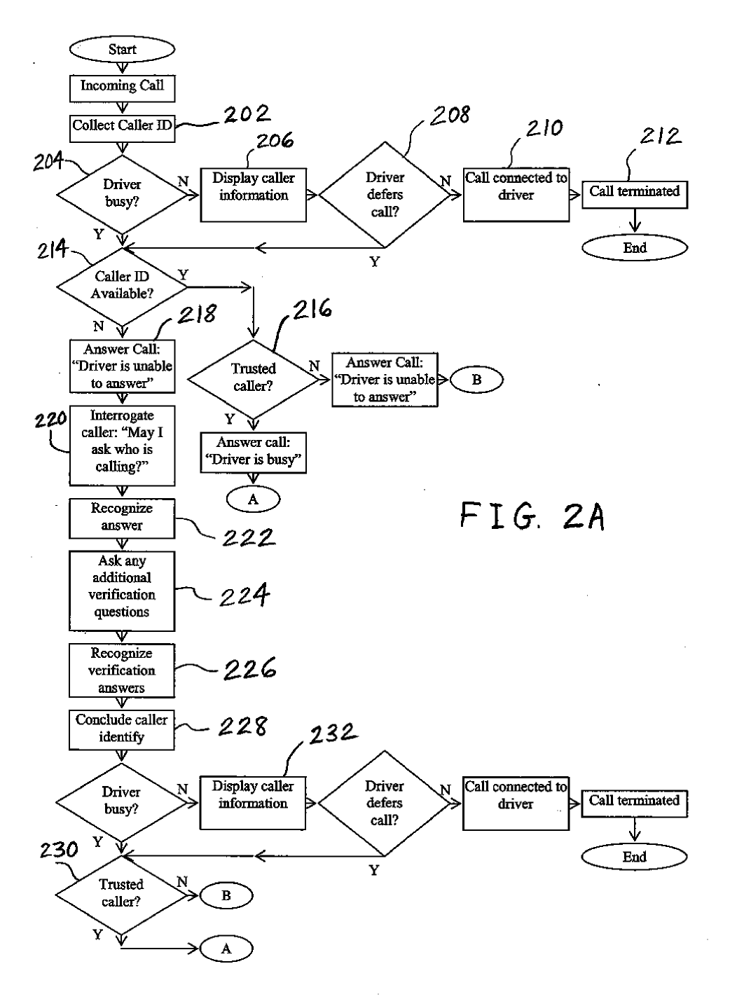

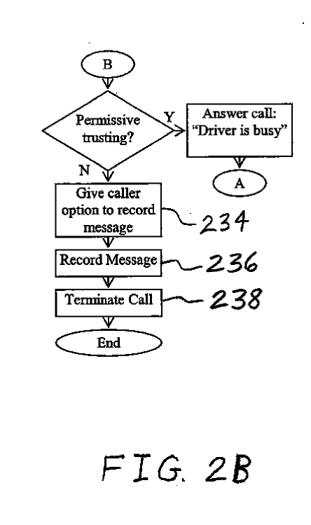

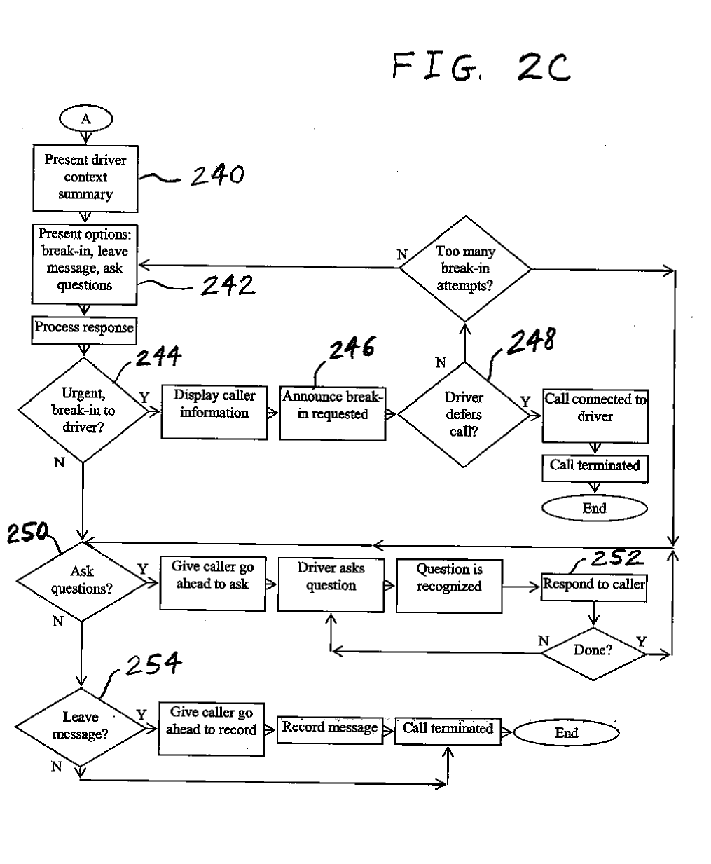

One embodiment of a voice proxy method of the present invention is illustrated in FIGS. 2A-C. In step 202, the system may collect any caller ID information that is available with the incoming call. If, in step 204, it is determined that the driver is not preoccupied or otherwise busy, then the caller information may be displayed (step 206). If the driver decides to accept the call (step 208), then the call is connected to the driver (step 210) and the call is eventually terminated (step 212).

If the driver is busy or preoccupied, or if the driver defers the call in step 208, then it is determined in step 214 whether the caller ID information is available. The system can attempt to find the caller's identity in a database of caller identities belonging to trusted parties (step 216). If the caller ID is found, then the system can assume that a trusted party has called.

If, however, caller ID information is not available with the incoming call, then the system can answer the call and use a natural language dialogue to determine the caller's identify. When the system answers the call, it may announce that the driver is unable to answer (step 218), and then ask the caller to identify himself (step 220). When the caller answers, that response can be processed and recognized by the system (step 222). Additional questions to verify the caller's identity may be given (step 224). The caller's responses to the questions may be processed and recognized (step 226). The system may make a determination of the caller's identity (step 228) and examine the database of caller identities to determine whether the caller is a trusted party (step 230).

At this time, the caller's identity is known and if this would not disrupt the driver's activities, the system may display or announce to the user that a call has come in, and also give the caller's identity (step 232).

If the driver allows the system to continue answering the call, and the caller is not a trusted party, the system will give the caller the option to leave a message (FIG. 2B; step 234). If the caller accepts that option, the system will prompt the user to state a message, record that message (step 236), and terminate the call (step 238). Common options in current practice, such as re-recording the message, deleting the message, and other voice message functions can be offered by the system. The message may also be in the form of recording a call back telephone number for the caller with or without the caller providing any voice or keystroke inputs.

If the driver allows the system to continue answering the call, and the caller is a trusted party, then the system may give additional information and options to the caller. The system may explain that the driver is busy and give a summary of the driver's situation and context. It may state that the driver is traveling to a particular destination with a particular estimated arrival time. The system can also state the driver's location and traffic situation so the caller will understand the driver's status (step 240). The traffic situation may include the vehicle's current speed, average speed over a previous period of time, and/or distance between the vehicle and other vehicles on the road. The system can also give several options to the caller (step 242).

One option would be to request a break-in, or attempt a direct connection to the driver, which could reflect an emergency or urgent matter that the caller must discuss with the driver (step 244). The caller may be asked to provide the nature of the call or the reason for urgency. This explanation may be provided to the driver (step 246) who may have the option to accept or decline the break-in request (step 248). The system can tell the caller that a break-in attempt will be tried, and it may fail, and the system can tell the caller that the attempt failed in the case where the driver does not accept the break-in request. This gives the driver some plausible social deniability of responsibility since the system or situation could be responsible for refusal.

Another option would be for the caller to ask the system for additional status and context information (step 250). For example, the caller might ask about the driver's schedule for the day and when an opening appears. The caller might also ask at what speed the driver is traveling, what road the driver is on or in which city, or to repeat or provide other additional detail to which the system is privy. Since the caller is a trusted party, such information can be shared (step 252). Callers might also be assigned particular levels of trust which would determine, with a more granular scale, the particular types and pieces of entrusted information that can be shared. For example, some less trusted parties may be told or allowed to inquire about estimated arrival times, but not current location or destination. The final option would be for the system to provide the option of recording a message from the caller (step 254).

In the example of directed call answering, as the driver receives a call, the system may determine that the driver is not too busy to take the call. The system may then announce to the driver that a call is coming in. If the system has received any caller ID information that is associated with the call, it can also announce that information.

If the driver does not wish to answer the call, the driver can ask the system to handle the call, either by selecting an option or using speech interaction, “Please handle the call”. The driver can also ask the system to start handling the call and report back who is calling, “Find out who is calling.”

At this point, the system may begin to handle the call, explaining that the driver cannot answer the phone. The system may need to identify the user, so the system may ask the caller to provide identification and verification, and in the meanwhile, the system may process and recognize the caller's answers. Once the identity of the caller has been determined, the system can provide this identify to the driver, if it is clear that the driver is not still too busy with the driving task. The system can provide this information graphically or verbally (through synthesized speech or playback of the caller's self-identification). The system can then provide the option for the driver to answer the call, or continue allowing the system to handle the call. As in the previously described case of automatic call answering, the system can determine whether the caller is a trusted party and handle the call in the appropriate manner.

This invention could be a feature added to driver information systems, in both variants: portable and factory installed in the car. Since many cell phones provide Bluetooth headset compatibility, it is easy for a system to connect to a vehicle operator's cell phone to handle calls coming into the car. Also, many driver information systems are able to “clone” GSM cards, which allows the driver information system to connect to the mobile telephone network and handle incoming and outgoing calls, thus replacing the mobile telephone on the network.

The system of the present invention monitors the vehicle dynamics, user behavior and position, navigation system settings, and traffic in order to handle incoming calls in various manners according to how busy or pre-occupied the driver appears to be. The system that determines whether the caller is a trusted party based on caller ID information or, lacking caller ID information, may ask the caller to self-identify and verify that identity using speech recognition and natural language understanding.

The caller may be allowed to leave a message, break-in to the called party if the need to communication with the called party is urgent, or ask the system questions about the driver's situation (e.g., location, destination, traffic conditions, estimated arrival time, speed, other items on the driver's schedule, etc.). The system may summarize the driver's situation to the caller (e.g., location, destination, traffic conditions, etc.) to provide context as to why the driver is not answering the call. Different levels of information about the driver may be provided to a caller, based on the fine grained trustworthiness level associated with the caller. Information may be provided from the driver navigation system to a caller who makes a call to the driver or a passenger of a vehicle.

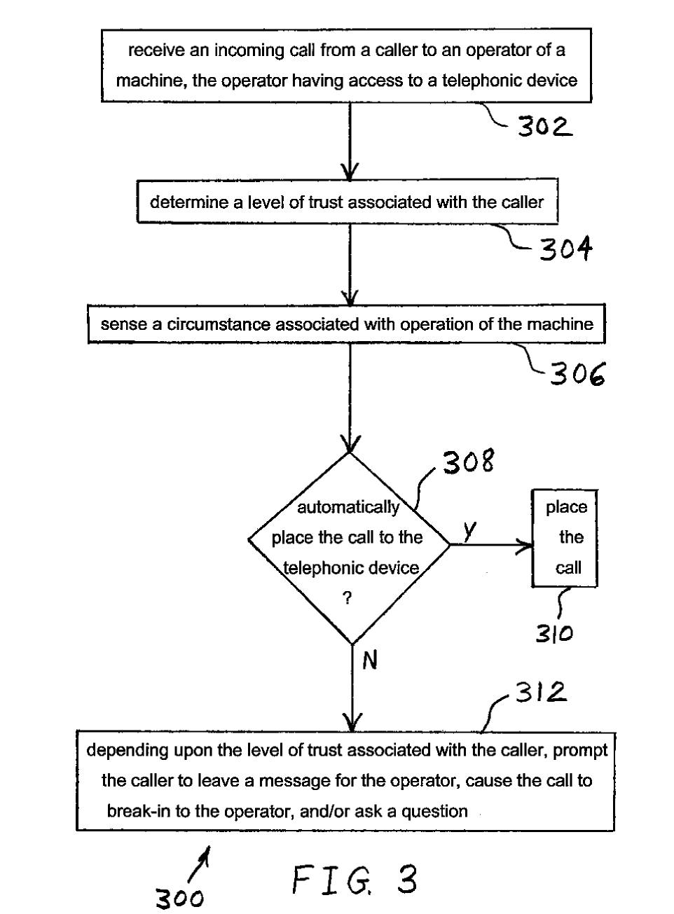

An embodiment of a method 300 of the present invention for operating a telephone system is illustrated in FIG. 3. In a first step 302, an incoming call from a caller to an operator of a machine is received. The operator has access to a telephonic device. For example, a vehicle may have a hands-free telephone system installed therein. The telephone system of the vehicle may receive an incoming call from a caller to the driver, or to a passenger, of the vehicle.

In a next step 304, a level of trust associated with the caller is determined. That is, the processor of the telephone system may identify the caller, such as by asking the caller for his identity, or by identifying the caller based upon a telephone number from which the caller is calling, or based upon some other caller identification that may be embedded in the signal associated with the incoming call. Once the identity of the caller has been determined, a level of trust associated with the caller may be retrieved from memory device 36. Each known potential caller may be placed in a corresponding one of two or more levels of trust.

Next, in step 306, a circumstance associated with operation of the machine is sensed. For example, information regarding a circumstance associated with operation of vehicle 10 may be provided by navigation system 18, speedometer 20, traffic sensor 24, weather sensors 26, traction sensors 28, steering sensors 30 and/or driver behavior sensors.

In step 308, it is decided whether to automatically place the call to the telephonic device. That is, it is decided whether to provide an audio and/or video cue to the user that a call has come in such that he may immediately answer it. In one embodiment, the decision is based upon at least one of the circumstances sensed in step 306. More particularly, if the circumstance is such that the driver's full attention is needed for the driving task at hand, then, in order to prevent the driver from becoming distracted by the incoming call, it may be decided not to automatically place the call to the telephonic device. For example, the driver may need to avoid distractions if the sensors indicate that the vehicle has left its intended path, the vehicle speed is above a threshold speed, the vehicle is in heavy traffic, it is nighttime, it is precipitating rain or snow outside, the vehicle has poor traction, the vehicle has been steering or turning beyond a threshold angle for at least a predetermined percentage of an immediately preceding time interval, and/or if the driver has been turned his head to look to one side or the other above a threshold number of times during an immediately preceding time interval.

If it is decided in step 308 that the demands of the driving task on the driver's attention are not too high, then the call may be placed to the driver in step 310. For example, the phone may ring and/or the driver may be provided with a visual cue that an incoming call is available.

On the other hand, if it is decided in step 308 that the demands of the driving task on the driver's attention are too high to safely place the call, then, depending upon the level of trust associated with the caller, as determined in step 304, the caller is prompted to leave a message for the operator, cause the call to break-in to the operator, and/or ask a question (step 312). For example, if the caller has a high level of trust, such as a family member, the caller may be provided with all three options, including breaking-in and placing the call with the driver regardless of the driving circumstances. If the caller has a mid-level of trust, such as a business associate (who may be identified as such by only a phone number from which the call was made), then the caller may be provided with only the options of leaving a message or asking a question of the system. For example, the system may provide an inquiring caller with an estimated time of arrival at a particular destination or current traffic conditions. If, however, the caller has the lowest level of trust, such as a total stranger, then the caller may be provided with only the option of leaving a message for the driver.

The present invention has also been described herein as being applied to a telephone as installed in a motor vehicle. However, it is to be understood that the present application encompasses any telephonic device to which a user has access. For example, the telephonic device may be a telephone installed in any machine being operated by the user, or a personal telephonic device, such as a cellular telephone.

The present invention has also been described herein as being applied to a driver of a motor vehicle. However, it may be readily appreciated that the present application is also applicable to any situation in which a user may be preoccupied with the operation of any machine, and thus may not want to receive a phone call at a particular point in time.

While this invention has been described as having an exemplary design, the present invention may be further modified within the spirit and scope of this disclosure. This application is therefore intended to cover any variations, uses, or adaptations of the invention using its general principles.

What is claimed is:

1. A method of operating a telephone system, comprising the steps of:
receiving an incoming call to an operator of a machine, the operator having access to a telephonic device;
sensing a circumstance associated with operation of the machine; and
deciding whether to place the call to the telephonic device, the deciding being dependent upon the sensed circumstance.

2. The method of claim 1 wherein the call is from a caller, the method comprising the further steps of:
determining a level of trust associated with the caller; and
choosing information to share with the caller, the information being associated with the operation of the machine, the choosing being dependent upon the level of trust associated with the caller.

3. The method of claim 2 wherein the determining step includes identifying the caller.

4. The method of claim 2 wherein the machine comprises a vehicle, the information including at least one of a destination of the vehicle, a speed of the vehicle, an estimated arrival time of the vehicle at the destination, a current location of the vehicle, and a traffic situation in which the vehicle is operating.

5. The method of claim 1 wherein the machine comprises a vehicle, the sensing being performed by at least one of a navigation system, a speedometer, a traffic sensor, a weather sensor, a traction sensor, a steering sensor, and a driver behavior sensor.

6. The method of claim 1 wherein the call is from a caller, the method comprising the further steps of:
determining a level of trust associated with the caller; and
providing at least one option to the caller, the at least one option being dependent upon the level of trust associated with the caller.

7. The method of claim 1 wherein the machine comprises a vehicle including a navigation system, the call being from a caller, the method comprising the further step of providing information from the navigation system to the caller.

8. A telephone system, comprising:
at least one sensor configured to sense a circumstance associated with operation of a machine; and
a processor communicatively coupled to the at least one sensor, the processor being configured to receive a call intended for an operator of the machine and to decide whether to:
forward the call to the operator;
ask the operator how to handle the call; or
record a message associated with the incoming call,
wherein the deciding is dependent upon the circumstance sensed by the at least one sensor.

9. The system of claim 8 wherein the call is from a caller, the processor being configured to:
determine a level of trust associated with the caller; and
choose information to share with the caller, the information being associated with the operation of the machine, the choosing being dependent upon the level of trust associated with the caller.

10. The system of claim 9 wherein the processor is configured to identify the caller.

11. The system of claim 9 wherein the machine comprises a vehicle, the information including at least one of a destination of the vehicle, a speed of the vehicle, an estimated arrival time of the vehicle at the destination, a current location of the vehicle, and a traffic situation in which the vehicle is operating.

12. The system of claim 8 wherein the machine comprises a vehicle, the sensor comprising at least one of a navigation system, a speedometer, a traffic sensor, a weather sensor, a traction sensor, a steering sensor, and a driver behavior sensor.

13. The system of claim 8 wherein the call is from a caller, the processor being configured to:
determine a level of trust associated with the caller; and
provide at least one option to the caller, the at least one option being dependent upon the level of trust associated with the caller.

14. The system of claim 8 wherein the machine comprises a vehicle including a navigation system, the call being from a caller, the processor being configured to provide information from the navigation system to the caller.

15. A method of operating a telephone system, comprising the steps of:
receiving an incoming call from a caller to an operator of a machine, the operator having access to a telephonic device;
sensing a circumstance associated with operation of the machine;
determining a level of trust associated with the caller;
deciding whether to automatically place the call to the telephonic device, the deciding being dependent upon the sensed circumstance; and
if the deciding step includes deciding not to automatically place the call to the telephonic device, then, depending upon the level of trust associated with the caller, prompting the caller to at least one of:
leave a message for the operator;
cause the call to break-in to the operator; and
ask a question regarding operation of the machine.

16. The method of claim 15 wherein the machine comprises a vehicle, the question regarding at least one of a destination of the vehicle, a speed of the vehicle, an estimated arrival time of the vehicle at the destination, a current location of the vehicle, and a traffic situation in which the vehicle is operating.

17. The method of claim 15 comprising the further step of choosing information to share with the caller, the information being associated with the operation of the machine, the choosing being dependent upon the level of trust associated with the caller.

18. The method of claim 17 wherein the machine comprises a vehicle, the information including at least one of a destination of the vehicle, a speed of the vehicle, an estimated arrival time of the vehicle at the destination, a current location of the vehicle, and a traffic situation in which the vehicle is operating.

19. The method of claim 15 wherein the determining step includes identifying the caller and retrieving the level of trust from a memory device.

20. The method of claim 15 wherein the machine comprises a vehicle, the sensing being performed by at least one of a navigation system, a speedometer, a traffic sensor, a weather sensor, a traction sensor, a steering sensor, and a driver behavior sensor.
